(19) United States
(12) Patent Application Publication
(10) Pub. No.: US 2022/0034152 A1
(43) Pub. Date: Feb. 3, 2022

(54) SPACER WITH METALLIC SIDE SECTIONS

(71) Applicant: SAINT-GOBAIN GLASS FRANCE, COURBEVOIE (FR)

(72) Inventors: Hans-Werner KUSTER, AACHEN (DE); Walter SCHREIBER, AACHEN (DE); Jean-Christophe LAFON, NOGENTEL (FR)

(21) Appl. No.: 17/276,013

(22) PCT Filed: Sep. 6, 2019
(86) PCT No.: PCT/EP2019/073798

§ 371 Date: Mar. 12, 2021

(30) Foreign Application Priority Data
Sep. 13, 2018 (EP) 18194244.2

(51) Int. Cl. E06B 3/663

(52) U.S. Cl. CPC E06B 3/66323; E06B 3/66366; E06B 3/66319; E06B 2003/66395; E06B 2003/6638

(57) ABSTRACT

A spacer for insulating glass units, includes a U-shaped main body extending in the longitudinal direction including a first metallic side section, a second metallic side section arranged parallel thereto, a polymeric connecting piece extending in the transverse direction, which connects the two metallic side sections and forms the lower limit of the main body, and an intermediate space arranged above the polymeric connecting piece between the metallic side sections. The first and second metallic side sections each include a side wall for connecting to a glass pane and a retaining arm, which protrudes into the intermediate space, and the retaining arm forms an assembly groove with the side wall, which groove runs substantially parallel to the side wall. The polymeric connecting piece is U-shaped and its two legs are inserted into the assembly grooves of the two metallic side sections.

The invention relates to a spacer for insulating glass units, a method for producing a spacer, an insulating glass unit, a method for producing an insulating glass unit, and use thereof.

Insulating glazings usually contain at least two panes made of glass or polymeric materials. The panes are separated from one another via a gas or vacuum space defined by the spacer. The thermal insulation capacity of insulating glass is significantly greater than that of single-pane glass and can be even further increased and improved in multiple glazings or with special coatings. Thus, for example, silver-containing coatings enable reduced transmittance of infrared radiation and thus reduce the cooling of a building in the winter.

In addition to the nature and the structure of the glass, the other components of an insulating glazing are also of great significance. The seal and especially the spacer have a major influence on the quality of the insulating glazing. Especially the contact points between the spacer and the glass pane are very susceptible to temperature and climate fluctuations. The connection between the pane and the spacer is produced via an adhesive bond of an organic polymer, for example, polyisobutylene. Besides the direct effects of temperature fluctuations on the physical properties of the adhesive bond, the glass itself in particular has an effect on the adhesive bond. The glass and spacers have different coefficients of linear thermal expansion, in other words, temperature changes cause them to expand differently. Due to changes in temperature, for example, from sunlight, the glass expands or contracts again upon cooling. The spacer does not make these movements to the same extent, especially in the case of rigid closed hollow-body profiles. Consequently, this mechanical movement expands or compresses the adhesive bond, which can compensate these movements only to a limited extent through its own elasticity. During the course of the service life of the insulating glazing, the mechanical stress described can result in partial or complete areal detachment of the adhesive bond. This detachment of the adhesive bond can subsequently enable penetration of humidity inside the insulating glazing. These climatic loads can lead to condensation in the region of the panes and a decrease in the insulating effect. It is thus desirable to equalize the coefficients of linear expansion of glass and spacers as much as possible and to modify the spacer such that the mechanical stress on the adhesive bond is as low as possible, thus lengthening the service life.

The thermal insulation properties of insulating glazings are quite significantly influenced by the thermal conductivity in the region of the edge seal, in particular of the spacer. In the case of exclusively metallic spacers, the high thermal conductivity of the metal causes the formation of a thermal bridge at the edge of the glass. This thermal bridge leads, on the one hand, to heat losses in the edge region of the insulating glazing and, on the other, with high humidity and low outside temperatures, to the formation of condensation on the inner pane in the region of the spacer. To solve these problems, thermally optimized so-called “warm-edge” systems in which the spacers are made of materials with lower thermal conductivity, in particular plastics, are increasingly used.

From the standpoint of thermal conductivity, polymeric spacers are to be preferred over metallic spacers. However, polymeric spacers have several disadvantages. For one thing, the tightness of a pure polymeric spacer relative to moisture and gas loss is insufficient. Here, there are various solutions, in particular concerning applying a barrier film on the outer side of the spacer (see, for example, WO2013/104507 A1). For another, the coefficients of linear expansion of plastics are much greater than those of glass, resulting in the problems described above.

U.S. Pat. No. 5,630,306A describes a modular spacer with two metallic side sections, which has a plastic boundary toward the inner and outer interpane space in each case. Thus, heat conduction from the inner pane to the outer pane is interrupted by the boundaries toward the inner and outer interpane space. This improves the thermal insulation properties of the edge seal. A substantial disadvantage of the spacer disclosed is its complicated production method: The metallic side sections are heated to such an extent that they are heated beyond the softening temperature of the plastic. Then, the metallic side sections are connected to the boundaries toward the interpane space by pressing them together and the softened plastic penetrates through the special perforations of the metallic side sections. The boundaries made of plastic have in each case a thickness of at least 1 mm such that the attachment of the side sections can be done as described. With this thickness, the thermal conductivity through the boundaries to the interpane space is comparatively high, which results in non-optimal thermal insulation in the region of the edge seal.

The object of the present invention is, consequently, to provide an improved spacer that does not have the above-mentioned disadvantages, to provide an improved method for producing a spacer, and an improved insulating glass unit and a simplified method for production thereof.

The object of the present invention is accomplished according to the invention by a spacer for insulating glass units according to the independent claim 1. Preferred embodiments of the invention emerge from the dependent claims. A method for producing a spacer according to the invention, an insulating glass unit according to the invention, a method for producing the insulating glass unit according to the invention, and their use according to the invention emerge from further independent claims.

The spacer according to the invention for insulating glass units comprises at least one U-shaped main body extending in the longitudinal direction (X direction). The main body includes a first metallic side section, a second metallic side section arranged parallel thereto, and, extending in the transverse direction (Y direction), a polymeric connecting piece, which connects the two metallic side sections to one another and establishes the necessary stiffness of the main body. The polymeric connecting piece forms the lower limit of the main body and defines the distance between the outer glass panes in the finished insulating glass unit. In the finished insulating glass unit, the lower limit is the one that points in the direction of the outer interpane space. Situated above the polymeric connecting piece between the metallic side sections is the intermediate space of the main body. The intermediate space points, in the finished insulating glass unit, in the direction of the inner interpane space.

The first and second metallic side sections have a side wall for connecting to a glass pane and a retaining arm. The side wall of a metallic side section serves, in the finished insulating glass unit, for attaching a glass pane. The side wall and the retaining arm protruding into the intermediate space form an assembly groove that runs substantially parallel to the side wall. The assembly groove serves for attaching the polymeric connecting piece. The polymeric connecting piece is U-shaped and has two legs. These legs are inserted into the assembly grooves of the two metallic side sections.

The spacer according to the invention is significantly improved compared to the known spacers. Due to the design with two metallic side sections, there is a secure and long-term stable attachment of the glass panes, since the coefficients of linear expansion of glass and metals do not differ so much as those of glass and polymers. Thus, the mechanical loading of the glass/spacer connection point is considerably reduced compared to pure polymeric spacers. The polymeric connecting piece, which establishes the distance between the two glass panes, results in a significant improvement in thermal insulation compared to purely metallic spacers. As a result of the separation of the two metallic side sections, there is no continuous thermal bridge between the two outer glass panes.

The type of attachment of the U-shaped polymeric connecting piece via the two legs into the two assembly grooves of the metallic side sections, which grooves run parallel to the side walls, ensures a long-term stable connection of the individual components of the main body. Even in the case of strong heating of the insulating glass unit, with the glass panes bulging outward toward the sides and thus pulling the metallic side sections apart to a certain extent in the transverse direction (Y direction), there is a secure attachment in the assembly grooves. Slipping out is not possible. Since the main body is U-shaped, the side sections can join in the movements of the glass panes during temperature changes since the two legs can be pressed or pulled outward or inward. This is a significant advantage compared to closed rigid hollow profile spacers. A particular advantage of the modular structure is that the spacer according to the invention can be manufactured for any desired distance between the glass panes, with only the polymeric connecting piece having to be adapted in its width. The metallic side sections can be used for any polymeric connecting piece. This increases the flexibility of production substantially compared to prior art spacers. A further advantage of the modular structure is the capability of disassembling the spacer into its individual components at the end of the service life of the insulating glass unit and thus recycling it. Thus, in many respects, the spacer according to the invention provides an improved solution compared to the prior art.

Unless explicitly stated, the description of the arrangement of the individual parts (parallel, angle) refers to the arrangement in the Y-Z sectional plane, as it is also depicted in the cross-sections in the figures.

In a preferred embodiment of the spacer according to the invention, the two metallic side sections have in each case a fixing projection, which surrounds a corner region of the U-shaped polymeric connecting piece in each case. This fixing projection ensures secure fixing of the polymeric connecting piece in the assembly groove and protects against damage to the main body at the connection between the polymeric connecting piece and the metallic side section. The fixing projection is preferably implemented as an extension of the side wall of a metallic side section and is then bent around the corner region of the U-shaped polymeric connecting piece or kinked along a prefabricated indentation. Preferably, the fixing projection forms an angle of approx. 90° with the side wall.

In a preferred embodiment of the spacer according to the invention, the fixing projection of one side section extends in the transverse direction at least as far as the retaining arm such that the polymeric connecting piece is clamped between the fixing projection and the retaining arm. A fixing projection preferably extends at most far enough that a minimum region of 2 mm of the polymeric connecting piece remains free. This minimum distance ensures that effective thermal separation is achieved such that no heat transfer from the first metallic side section to the second metallic side section occurs.

The polymeric connecting piece typically has thermal conductivity between 0.1 and 0.5 Wm⁻¹ K₋₁.

In a preferred embodiment, the polymeric connecting piece contains polyethylene (PE), polycarbonate (PC), polypropylene (PP), polyethylene terephthalate (PET), polyethylene terephthalate-glycol (PET-G), polyoxymethylene (POM), polyamides, polybutylene terephthalate (PBT), PET/PC, PBT/PC, and/or copolymers thereof. In a particularly preferred embodiment, the polymeric connecting piece consists substantially of one of the polymers listed. These materials provide the necessary stability, even at low thicknesses. Particularly preferably, the polymeric connecting piece is made of PET.

The total thickness of the polymeric connecting piece is between 0.1 mm and 5 mm, preferably between 0.2 mm and 2 mm. At these low thicknesses, the heat conduction through the polymeric connecting piece is reduced and, at the same time, the stability is sufficient for use in the insulating glazing.

In a preferred embodiment of the spacer according to the invention, the polymeric connecting piece includes at least one moisture-proof barrier. The moisture-proof barrier prevents the penetration of moisture into the inner interpane space and thus prevents fogging of the panes from the inside. In addition, the barrier improves the gas tightness of the insulating glass unit, which is important when gas filling is present. The service life of the insulating glazing with the spacer according to the invention is thus extended. The moisture-proof barrier can be a metal coating, a ceramic coating, a metal foil, a polymeric film, or a multilayer foil with polymeric and metallic layers or with polymeric and ceramic layers or with polymeric, metallic, and ceramic layers. Suitable are the barrier films known to the person skilled in the art as already used for customary prior art polymeric hollow profile spacers and as are described, for example, in the documents WO2013/104507 A1, WO2016/046081 A1, WO2012/140005 A1.

The moisture-proof barrier is preferably a metal-containing barrier coating or a metal-containing barrier film. Metal-containing coatings and films seal particularly well against the penetration of water, since they contain at least one metallic layer. The thickness of this at least one metallic layer is between 0.01 μm and 0.2 μm. Preferably, a plurality of thin metallic layers each with a thickness of between 0.01 μm and 0.1 μm are used. Within the layer thicknesses mentioned, particularly good tightness of the barrier film is achieved.

Metallic layers or coatings preferably contain or are made of iron, aluminum, silver, copper, gold, chromium, and/or alloys or oxides thereof, particularly preferably aluminum and/or aluminum oxide.

In the case of a multilayer metal-containing barrier film, one or more polymeric layers can also be contained in addition to metallic layers. A polymeric layer of the barrier film preferably includes polyethylene terephthalate, ethylene vinyl alcohol, polyvinylidene chloride, polyamides, polyethylene, polypropylene, silicones, acrylonitriles, polyacrylates, polymethyl acrylates, and/or copolymers or mixtures thereof.

Ceramic layers or coatings preferably contain or are made of silicon oxides and/or silicon nitrides.

In a preferred embodiment of the spacer according to the invention, the polymeric connecting piece includes at least one moisture-proof barrier, which is arranged on the side of the polymeric connecting piece facing the intermediate space. The moisture-proof barrier is thus protected against damage during installation in the insulating glazing or during storage and transport of the spacer.

In a preferred embodiment, the moisture-proof barrier is arranged at least on the part of the polymeric connecting piece that extends in the transverse direction between the first metallic side section and the second metallic side section. This ensures a good seal of the inner interpane space, since there is then a closed sealing plane composed of metallic side sections and a moisture-proof barrier adjacent thereto. Particularly preferably, at least one side of the polymeric connecting piece is completely covered with the moisture-proof barrier. This is simple to produce from a production engineering standpoint and ensures a particularly good seal.

In a preferred embodiment of the spacer according to the invention, the polymeric connecting piece includes, on the side facing away from the intermediate space, an adhesion-promoter layer that is used to improve the adhesion of the secondary sealant in the finished insulating glazing. This adhesion-promoter layer is arranged as the outermost layer on the polymeric connecting piece such that, in the finished insulating glazing, it makes contact with the secondary sealant. Possible adhesion-promoter layers include chemical pretreatment, a metal-containing thin film, or a ceramic thin film. A thin film preferably has a thickness between 5 nm and 30 nm.

In a preferred embodiment, a sealing means, such as a polyisobutylene (butyl), is provided in the assembly groove. The sealing means ensures a good moisture-proof connection between the metallic side sections and the polymeric connecting piece such that penetration of moisture into the inner interpane space is prevented. Preferably, the sealing means is applied in the assembly groove at the point where the support arm is adjacent the side wall. This is thus the part of the assembly groove that is nearest the inner interpane space. When the sealing means is pre-applied in the metallic side sections and the polymeric connecting piece is subsequently inserted, a perfect seal is achieved because part of the sealing means is displaced by the polymeric connecting piece and is thus distributed in the assembly groove. Preferably, the sealing means in the assembly groove is provided as a butyl cord. This is easy to apply and provides an excellent seal.

The metallic side sections preferably contain or are made of aluminum, stainless steel, or steel. These materials are readily processable and provide particularly good results in the matching of the coefficient of linear expansion. Particularly preferably, extruded metallic side sections are made substantially of aluminum, since it is particularly readily extrudable. Particularly preferably, metallic side sections produced by roll forming are made of a coated steel that is preferably coated with an adhesion promoter. Compared to aluminum, steel has lower thermal conductivity and good linear expansion. In addition, steel is very stable and more economical than stainless steel.

The metallic side sections preferably have a wall thickness of 0.05 mm to 1.5 mm. In this range, the spacer is stable and, at the same time, flexible enough to be easily bent to form a spacer frame.

In a preferred embodiment, the two metallic side sections include in each case an assembly groove that extends along the entire height of the side wall. In other words, the retaining arm runs substantially over the entire height of the side wall parallel to the side wall. In this embodiment, the assembly groove has its maximum size, by means of which a particularly stable fixing of the U-shaped polymeric connecting piece is achieved. The height of side wall corresponds to the extension of the side wall in the Z direction and corresponds to the height of the spacer.

In another preferred embodiment of the spacer according to the invention, the two metallic side sections comprise an assembly groove, which extends over at least 40% of the height of the respective side wall, but not over the entire height of the side wall. Compared to the previously described embodiment, the material outlay for the polymeric connecting piece and the metallic side section is less, since the retaining arm is shorter and the assembly groove smaller. Nevertheless, stable fixing of the polymeric connecting piece can be achieved. Particularly preferably, the assembly groove extends over at least 50% of the height of the respective side wall, since this provides good fixing.

In a preferred embodiment, the assembly grooves have profiling by means of which the fixing of the polymeric connecting piece is improved. The profiling is preferably arranged in the form of longitudinal grooves that extend in the longitudinal direction (X direction). Alternatively, barbs can also be placed in the assembly groove to provide good retention of the legs of the polymeric connecting piece. Particularly preferably, profiling is arranged on the retaining arm and the side wall.

In a preferred embodiment of the spacer according to the invention, the metallic side sections are produced by roll forming. Metallic side sections produced by roll forming are thinner and, consequently, more economical due to the lower material thickness. Manufacturers that have the corresponding machines at their disposal can thus readily produce the metallic side sections. Preferably, the metallic side sections have a wall thickness of 0.05 mm to 0.5 mm. These material thicknesses can be easily processed and are nevertheless stable. Alternatively, the metallic side sections are produced by extrusion. All that is needed is a suitable shaping tool that corresponds to the cross-section of the metallic side sections. The acquisition of such a shaping tool is profitable even for relatively low production numbers. The side sections produced by extrusion are generally somewhat thicker and thus have higher stability. Preferably, side sections produced by extrusion have a wall thickness of approx. 0.5 mm to 1.5 mm.

In a preferred embodiment of the spacer according to the invention, a desiccant is arranged in the intermediate space of the spacer. Suitable desiccants are, for example, silica gels, molecular sieves, CaCl₂, Na₂SO₄, activated carbon, silicates, bentonites, zeolites, and/or mixtures thereof. The desiccant is used to absorb moisture from the inner interpane space and thus to prevent fogging of the panes. In the simplest form, the desiccant is arranged as bulk material in the intermediate space.

Preferably, the desiccant is integrated into the intermediate space in the form of at least one continuous desiccant body. A desiccant body preferably has the form of a strip or flexible hose that is fastened in the intermediate space. Preferably, a desiccant body is attached only on one of the metallic side sections and does not make contact with the other metallic side section. The desiccant body thus does not extend over the entire intermediate space in the transverse direction (Y direction). Thus, transfer of heat from one metallic side section to the other metallic side section is prevented, resulting in improved thermal insulation. In the case of multiple desiccant bodies, a gap of at least 2 mm, measured as the distance in the transverse direction (Y direction) preferably remains between the individual desiccant bodies. This ensures effective thermal separation. Preferably, the desiccant body is arranged such that it is also not in contact with the polymeric connecting piece.

The desiccant body is preferably a prefabricated body in which the desiccant is enclosed, thus preventing the desiccant from being freely distributed in the inner interpane space. Preferably, the desiccant is integrated in a binding agent, particularly preferably coextruded therewith. This is particularly easy to produce and prevents the desiccant from being distributed in the inner interpane space. The desiccant strip thus obtained can then be fastened in the intermediate space of the spacer to create a completely prefabricated spacer that can be assembled to form a frame and then can be installed directly in the insulating glazing. Various polymers or foams thereof, such as polyurethanes and silicones, are suitable as binding agents. Alternatively preferred, the desiccant as bulk material is surrounded by a thin water-vapor permeable casing and this is then fastened in the intermediate space of the spacer.

In a preferred embodiment of the spacer according to the invention, a cover film is attached to the side facing the inner interpane space in the insulating glazing. This cover film extends in the transverse direction between the first metallic side section and the second metallic side section and thus closes the intermediate space to form a cavity.

The cover film is a stretchable and flexible film that can follow the movements of the spacer during heating of the insulating glass unit (outward bulging of the panes) and cooling of the insulating glass unit (inward bulging of the panes) without tearing and preferably without forming waves when the material shrinks at cold temperatures.

The cover film is preferably water-vapor permeable so the desiccant arranged in intermediate space can absorb moisture. The cover film serves to improve the visual appearance of the spacer and obscures the view of any desiccant present. It also prevents the penetration of particles of a desiccant into the inner interpane space. It can be imprinted with symbols or patterns as desired and can be freely colored in accordance with customer requirements. In the finished insulating glazing, essentially only the cover film of the spacer is visible.

The cover film can be attached by gluing, welding, clamping, or other suitable fastening methods. Preferably, the cover film at least partially surrounds the two metallic side sections in the upper region such that, in the finished insulating glazing, it is arranged between the glass pane or the primary sealant and the side wall of the metallic side section.

The cover film can be made of any material that preferably has low thermal conductivity between 0.1 and 0.5 W m⁻¹ K⁻¹. The cover film preferably contains or is made of polyethylene terephthalate (PET), polypropylene (PP), polyvinyl chloride (PVC), polyimide (PI), polytetrafluoroethylene (PTFE), or wood, leather, a composite material including polymer and wood, or another suitable material. The material is preferably resistant to UV radiation and, optionally, contains suitable stabilizers. However, it is implemented such that no outgassing of volatile substances can occur, which would result in fogging of the glass panes in the inner interpane space.

The cover film is preferably water-vapor permeable. In a preferred embodiment, the cover film has at least one, preferably multiple perforations. The total number of perforations depends on the size of the insulating glass unit. The perforations in the cover film connect the intermediate space to the inner interpane space, enabling gas exchange between them. This allows absorption of atmospheric humidity by a desiccant situated in the intermediate space and thus prevents fogging of the panes. In another preferred embodiment, the material of the cover film is porous or made of a diffusion-open material such that no perforations are required.

In another preferred embodiment of the spacer according to the invention, the spacer includes at least one incision with a V-shaped cross-section (V-shaped incision). The incision extends in the transverse direction (Y direction) of the spacer. The V-shaped incision is used to bend the spacer at this point to form a corner of a spacer frame. The V-shaped incision is arranged such that the open side of the V is arranged on the upper side of the spacer, i.e., on the side that faces the inner interpane space. The point of the V reaches only as far as the base of the U-shaped polymeric connecting piece such that the polymeric connecting piece is not cut into. Thus, the corner of the spacer frame formed remains closed by the polymeric connecting piece. The base of the U-shaped polymeric connecting piece is the part that connects the two legs, i.e., extends between the two metallic side sections in the Y direction. Preferably, the first and second metallic side sections have in each case a fixing projection, which is also not affected by the incision. Thus, after bending, the fixing projection provides an additional stabilizing effect in the corner of the spacer frame.

The spacer has a width of 5 mm to 55 mm, preferably of 12 mm to 33 mm. In the context of the invention, the width is the dimension extending between the side walls. The width of the spacer is the distance between the surfaces of the two side walls of the first and second metallic side sections facing away from one another. The selection of the width determines the distance between the panes of the insulating glass unit. The exact dimension is governed by the dimensions of the insulating glass unit and the desired size of the interpane space.

The spacer preferably has, along the side walls, a height of 5 mm to 15 mm, particularly preferably of 6 mm to 9 mm. In this range for the height, the spacer has advantageous stability, but is, on the other hand, advantageously inconspicuous in the insulating glass unit. In addition, the intermediate space of the spacer thus has an advantageous size for accommodating a suitable amount of desiccant.

In another preferred embodiment of the spacer according to the invention, the spacer includes at least one receiving profile for an additional pane. Thanks to the receiving profile, the spacer according to the invention can accommodate a middle pane and is thus suitable for triple glazing or, optionally, quadruple glazing. The receiving profile is arranged between the first metallic side section and the second metallic side section and has a receiving groove for the additional pane extending in the longitudinal direction (X direction). The receiving profile divides the intermediate space of the spacer into a first intermediate space between the first metallic side section and the receiving profile and a second intermediate space between the receiving profile and the second metallic side section.

Preferably, the receiving groove has a cross-section in the shape of a U or V. An additional pane can be readily fixed in such a cross-section.

In a preferred embodiment, the receiving profile is, like the metallic side sections, produced as a metallic receiving profile. The metallic profiles are easy to process and produce as well as having the necessary stability to stabilize the middle pane. In addition, the leak tightness in the region of the receiving groove is ensured by the metallic implementation. Preferably, the metallic receiving profile is produced by extrusion or roll forming. Particularly preferably, the receiving profile is produced by the same method as the metallic side sections. Thus, only one technique is necessary for producing the metallic parts.

In a preferred embodiment of the spacer according to the invention, the U-shaped polymeric connecting piece is divided by the receiving profile into a first U-shaped polymeric connecting piece and a second U-shaped polymeric connecting piece. The receiving profile has a first inner assembly groove and a second inner assembly groove. The first inner assembly groove accommodates one leg of the first U-shaped polymeric connecting piece, and the second inner assembly groove accommodates one leg of the second polymeric connecting piece. Thus, the first intermediate space is delimited by the first metallic side section, the first U-shaped polymeric connecting piece, and the receiving profile. The second intermediate space is delimited by the receiving profile, the second U-shaped polymeric connecting piece, and the second metallic side section. The previously described preferred variants for the polymeric connecting piece also apply to the first and second U-shaped polymeric connecting piece.

In a preferred embodiment, the receiving profile has a first inner fixing projection that surrounds the corner region of the first U-shaped polymeric connecting piece and by means of which the first polymeric connecting piece is fixed in the first inner assembly groove. In addition, the receiving profile has a second inner fixing projection that surrounds the corner region of the second U-shaped polymeric connecting piece and by means of which the second polymeric connecting piece is fixed in the second inner assembly groove. The two inner fixing projections extend in each case in the transverse direction preferably over 0.5% to 20% of the entire width of the U-shaped main body, preferably over 1% to 10% of the entire width. However, they extend only far enough that the inner fixing projections do not make contact with the fixing projections of the metallic side sections such that no thermally conductive connection is created between two panes in the insulating glazing.

Preferably, an insert that prevents slippage of the pane with resulting development of noise when the window is opened and closed is arranged in the receiving groove. The insert further compensates for the thermal expansion of the third pane when heated such that, regardless of climatic conditions, tension-free fixing is ensured. Materials considered for the insert include, for example, polymer foams or sealants; preferred are butyl sealants, thermoplastic elastomers, urethane-based thermoplastic elastomers, silicone sealants, or an ethylene-propylene diene rubber.

Preferably, the insert is gas-permeable such that, in the finished insulating glazing, an air or gas exchange is possible between the two inner interpane spaces that are separated by the additional pane. This enables pressure equalization between the inner interpane spaces and thus results in a significant reduction of the stress on the middle pane.

In a preferred embodiment of the spacer according to the invention, a cover film that is subdivided into a first cover film and a second cover film by the receiving profile is arranged in the transverse direction (Y direction) between the first metallic side section and the second metallic side section. The first cover film extends from the first metallic side section all the way to the receiving profile in the transverse direction and closes the first intermediate space. A second cover film extends from the receiving profile all the way to the second metallic side section and closes the second intermediate space. The first and second cover film primarily serve aesthetic purposes and improve the visual appearance of the spacer in the finished insulating glazing, as has already been described above for the cover film.

Preferably, the receiving profile has a first support protrusion protruding in the direction of the first intermediate space and a second support protrusion protruding in the direction of the second intermediate space, on which the respective first or second cover film is attached. This simplifies the attachment by, for example, gluing to the receiving profile. The attachment to the metallic side sections has already been described above. Support protrusions can also be analogously attached to the metallic side sections.

The invention further includes a method for producing a spacer according to the invention at least comprising the following steps:
a) Extruding or roll forming the first metallic side section and the second metallic side section,
b) Providing the U-shaped polymeric connecting piece, and
c) Inserting and fixing the U-shaped polymeric connecting piece in the assembly grooves of the two metallic side sections.

In step a), the two metallic side sections are either extruded or bent from a metallic sheet using rollers. The advantage of extrusion is the comparatively low acquisition cost for a suitable shaping tool using which the metallic side sections can be produced on a large-scale. These side sections can then be used in large quantities for producing a wide variety of spacers with different widths or with additional receiving profiles. The same applies to the roll-formed metallic side sections, with, in this case, the acquisition of a suitable system for the roll forming of the side sections being more expensive. The advantage with roll forming is that very thin sheets can be used. This reduces the pure material costs of the subsequent spacer.

In step b), the U-shaped polymeric connecting piece is provided. For this, a suitable piece of film is bent, pressed, or extruded in a U-shape. Depending on the material, this can happen under heating. The polymeric connecting piece determines the width of the spacer. An optional moisture-proof barrier can be applied before or after producing the U shape.

In step c), the U-shaped polymeric connecting piece is inserted into the assembly grooves of the two metallic side sections. This can be fully automated since the metallic side sections only have to be pushed onto the polymeric connecting piece. The attachment of the U-shaped polymeric connecting piece can be accomplished in various ways. Clamping by pressing on a retaining arm is preferred. Alternatively preferred is attachment using an adhesive.

The method according to the invention comprising the steps a) through c) thus provides a simple capability for producing a spacer from a few prefabricated components. The assembly of the spacer can be automated or manual. Due to the modular design, the production can be easily adapted to different products.

In a preferred embodiment of the method according to the invention, the two metallic side sections include in each case a fixing projection, which is implemented in step a) as an extension in the Z-direction of the respective side wall. The side wall and the fixing projection thus enclose an angle β (beta) of 180°. In step c), first, the U-shaped polymeric connecting piece is inserted into the assembly groove and then, for attachment of the U-shaped polymeric connecting piece, the fixing projection is bent around such that the fixing projection surrounds the corner section of the U-shaped polymeric connecting piece. This is a simple and effective method of fixing the polymeric connecting piece in the assembly groove. This embodiment is particularly preferred when the metallic side sections had been produced by extrusion in step a). In this case, already at the time of extrusion, the metallic side sections can be provided with a kink where the thickness of the metal is less than in the rest of the side wall, facilitating bending of the fixing projection in step c).

In another preferred embodiment of the method according to the invention, the metallic side sections are implemented in step a) such that the retaining arm protrudes from the side wall by an angle α (alpha) greater than zero and less than 90°. Thus, the position of the assembly groove is already determined by a pre-shaped metal sheet. Then, in step c), after insertion of the U-shaped polymeric connecting piece, the respective retaining arm is pressed or bent in the direction of the side wall such that the U-shaped polymeric connecting piece is fixed in the assembly grooves. This embodiment of the method according to the invention is particularly preferred when the metallic side sections are produced by roll forming in step a). The pre-bending of the retaining arms can be carried out particularly well and easily in the roll forming process.

In a preferred embodiment of the method according to the invention, a desiccant is arranged in the intermediate space of the spacer. This can be done at various points in the method. Preferably, the desiccant is applied in the form of a continuous desiccant body. This is preferably done after step c), wherein the desiccant body is fixed in the intermediate space, preferably by extrusion. Alternatively preferably, one of the metallic side sections or an optionally present receiving profile is provided with a desiccant body; and, then, this prepared metallic side section or receiving profile is connected to the U-shaped polymeric connecting piece in step c).

In another preferred embodiment of the method according to the invention, a cover film is attached after step c) and, optionally, after application of a desiccant such that the intermediate space is closed off by the cover film.

In another preferred embodiment of the method according to the invention, before step c), a sealing means, preferably a butyl cord is introduced into the assembly groove, preferably extruded, injected, or inserted. This serves to improve the sealing of the spacer against the penetration of moisture. For improved sealing, the metallic side section is particularly preferably heated in the region of the sealing means before insertion of the U-shaped polymeric connecting piece. This increases the flowability of the sealing means, for example, of the butyl.

In another preferred embodiment of the method according to the invention, the spacer includes a receiving profile for an additional pane and the U-shaped polymeric connecting piece is divided into a first and a second polymeric connecting piece, as previously described for the spacer with the receiving profile. In this case, in step a) of the method according to the invention, the receiving profile is additionally produced by extrusion or roll forming. Subsequently, in step b), the first and second polymeric connecting piece are provided. In step c), the legs of the first and the second polymeric connecting pieces are inserted into the assembly grooves of the two metallic side sections and simultaneously inserted into the inner assembly grooves of the receiving profile. The attachment is done as previously described for the method according to the invention. The already described preferred embodiments of the method according to the invention apply analogously for the method for producing the spacer with a receiving profile.

The invention further includes another alternative method for producing a spacer according to the invention. The method comprises at least the following steps:
a) Providing a polymeric strip, which serves as the starting material for the polymeric connecting piece, but which is not yet bent into a U shape, being a flat strip instead,
b) Providing a first metallic sheet and a second metallic sheet, which serve as the starting material for the first metallic side section and the second metallic side section,
c) Bending the first metallic sheet around the polymeric strip, and bending the second metallic sheet around the polymeric strip such that the assembly grooves of the two metallic side sections are already produced,
d) Roll forming the workpiece produced in step c) to form a U-shaped main body.

This alternative method has the advantage of having fewer individual steps than with separate production of the metallic side sections and the polymeric connecting piece. Consequently, this is a simple, elegant method for producing a spacer according to the invention.

In a preferred variant of the method, before step c), a sealing means is applied to the two edges of the polymeric strip of the polymeric connecting piece such that a sealing means is arranged in the assembly groove in the finished spacer.

The invention further includes an insulating glass unit with at least a first pane, a second pane, a spacer according to the invention arranged circumferentially between the first and second pane, an inner interpane space, and an outer interpane space. The spacer according to the invention is arranged to form a circumferential spacer frame. The first pane is attached to the side wall of the first metallic side section of the spacer via a primary sealant, and the second pane is attached to the side wall of the second metallic side section of the spacer via a primary sealant. This means that a primary sealant is arranged between the side wall of the first metallic side section and the first pane as well as between the side wall of the second metallic side section and the second pane. The first pane and the second pane are arranged parallel and preferably congruently. The edges of the two panes are therefore arranged preferably flush in the edge region, i.e., they are at the same height. The spacer delimits the inner interpane space relative to the outer interpane space and separates them from one another. The inner interpane space is delimited by the first and second pane and the section facing inward, i.e., optionally the cover film. The outer interpane space is defined as the space that is delimited by the first pane, the second pane, and the outward facing section of the spacer, i.e., substantially by the polymeric connecting piece. The outer interpane space is at least partially filled with a secondary sealant. The secondary sealant contributes to the mechanical stability of the insulating glass unit and absorbs some of the climatic loads acting on the edge seal. A particular advantage of the insulating glass unit according to the invention is that the primary sealant is in contact only with the metallic side sections and not with polymeric regions of the spacer. Thus, no leakage can occur due to interfacial diffusion as often occurs with prior art spacers at the interface between metallic foils and the polymeric main body.

In another preferred embodiment of the insulating glass unit according to the invention, the secondary sealant is applied along the first pane and the second pane such that a central region of the polymeric connecting piece is free of secondary sealant. The “central region” refers to a region arranged distant from the two outer panes relative to the these panes, in contrast to the two outer regions of the polymeric connecting piece, which are adjacent the first pane and the second pane. In this manner, good stabilization of the insulating glass unit is obtained, while, at the same time, material costs for the secondary sealant are saved. In addition, the thermal insulation in the region of the edge seal is improved since no continuous thermally conductive sealing compound is present between the first and the second pane. At the same time, this arrangement is easily produced by applying two strands of secondary sealant in each case on the spacer in the outer region adjacent the outer panes.

In another preferred embodiment, the secondary sealant is attached such that the entire outer interpane space is completely filled with secondary sealant. This results in maximum stabilization of the insulating glass unit.

Preferably, the secondary sealant contains polymers or silane-modified polymers, particularly preferably organic polysulfides, silicones, room-temperature-vulcanizing (RTV) silicone rubber, peroxide-vulcanizing silicone rubber, and/or addition-vulcanizing silicone rubber, polyurethanes, and/or butyl rubber. These sealants have a particularly good stabilizing effect.

The primary sealant preferably contains a polyisobutylene. The polyisobutylene can be a cross-linking or non-cross-linking polyisobutylene.

The first pane and the second pane of the insulating glass unit preferably contain glass, ceramic, and/or polymers, particularly preferably quartz glass, borosilicate glass, soda lime glass, polymethyl methacrylate, or polycarbonate.

The first pane and the second pane have a thickness of 2 mm to 50 mm, preferably 3 mm to 16 mm, with the two panes possibly even having different thicknesses.

In a preferred embodiment of the insulating glass unit according to the invention, the spacer frame consists of one or a plurality of spacers according to the invention. For example, one spacer according to the invention can be bent to form a complete frame. Also, multiple spacers according to the invention can be linked to one another by one or a plurality of plug connectors. The plug connectors can be implemented as longitudinal connectors or corner connectors. Such corner connectors can, for example, be implemented as plastic molded parts with a seal, in which two mitered spacers abut.

In a preferred embodiment of the insulating glass unit according to the invention, the spacer is provided with V-shaped incisions. The spacer can be bent at the V-shaped incisions such that a corner of the spacer frame is created there. The corners are closed at the interfaces by welding or gluing. In this manner, the spacer frame can be produced stably and easily without additional corner connectors or longitudinal connectors.

In principle, a wide variety of geometries of the insulating glass unit are possible, for example, rectangular, trapezoidal, and rounded shapes.

In another embodiment, the insulating glazing includes more than two panes. In this case, the spacer according to the invention can include a receiving profile with a receiving groove in which at least one additional pane is arranged. The above-described embodiments for the insulating glazing apply mutatis mutandis to the embodiment with more than two panes.

A plurality of panes can also be implemented as a composite pane.

The invention further includes a method for production of an insulating glass unit according to the invention comprising the steps:
a) Providing a spacer according to the invention,
b) Bending the spacer to form a closed spacer frame,
c) Providing a first pane and a second pane,
d) Fixing the spacer between the first and the second pane via a primary sealant,
e) Pressing the pane assembly comprising the first pane, the spacer frame, and the second pane, and
f) Filling the outer interpane space with a secondary sealant, wherein the filling is at least partial.

The production of the insulating glass unit is done manually or by machine on multiglazing systems known to the person skilled in the art. First, a spacer according to the invention is provided. This spacer is shaped to form a spacer frame. Preferably, the spacer frame is produced by bending the spacer according to the invention to form a frame, which is closed at one point by welding, gluing, and/or using a plug connector. A first pane and a second pane are provided and the spacer is fixed between the first and the second pane via a primary sealant. The outer interpane space is at least partially filled with a secondary sealant. The method according to the invention thus enables simple and economical production of an insulating glass unit. No special new machines are required, since, thanks to the design of the spacer according to the invention, conventional bending machines as are already available for metallic cold bendable spacers can be used.

The invention further includes the use of the insulating glass unit according to the invention as a building interior glazing, a building exterior glazing, and/or a façade glazing.

The invention is explained in detail in the following with reference to drawings. The drawings are purely schematic representations and not to scale. They in no way restrict the invention. They depict:

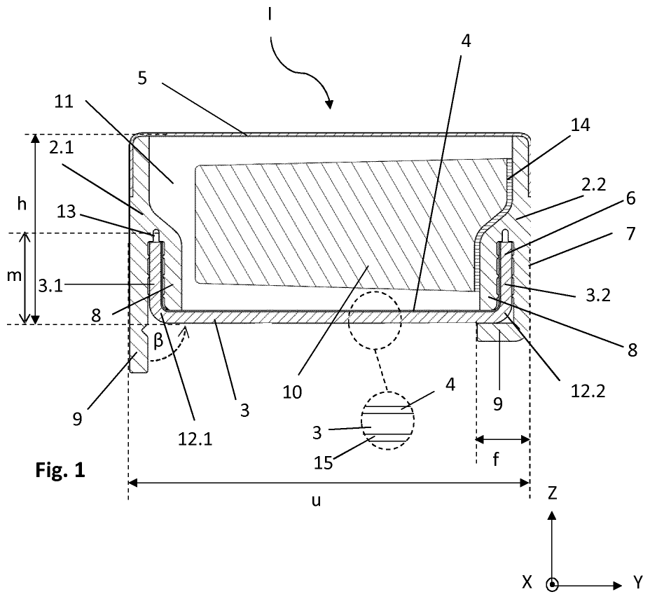

FIG. 1 a cross-section of a possible embodiment of a spacer according to the invention,

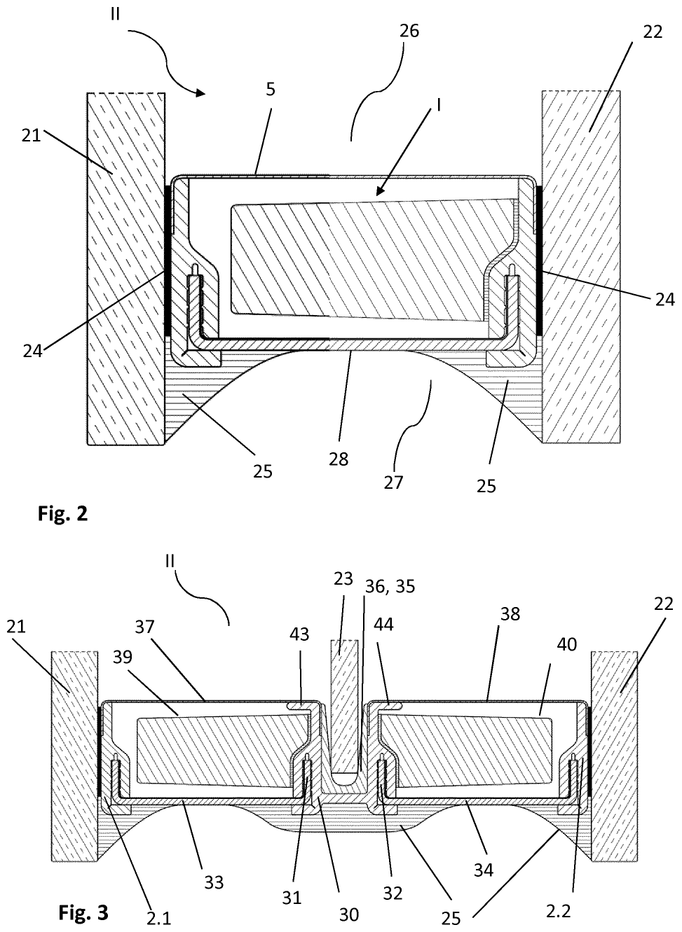

FIG. 2 a cross-section of a possible embodiment of an insulating glass unit according to the invention,

FIG. 3 a cross-section of another possible embodiment of an insulating glass unit according to the invention,

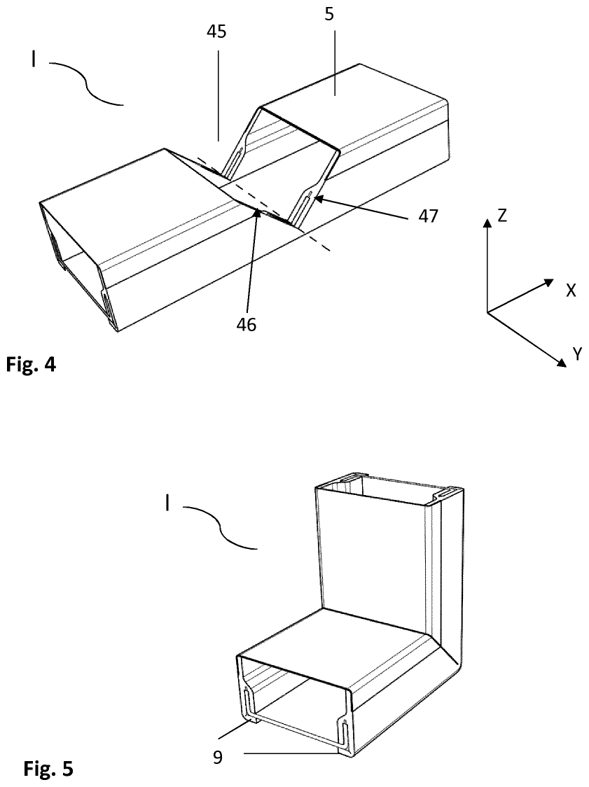

FIG. 4 a perspective side view of a spacer according to the invention with an incision,

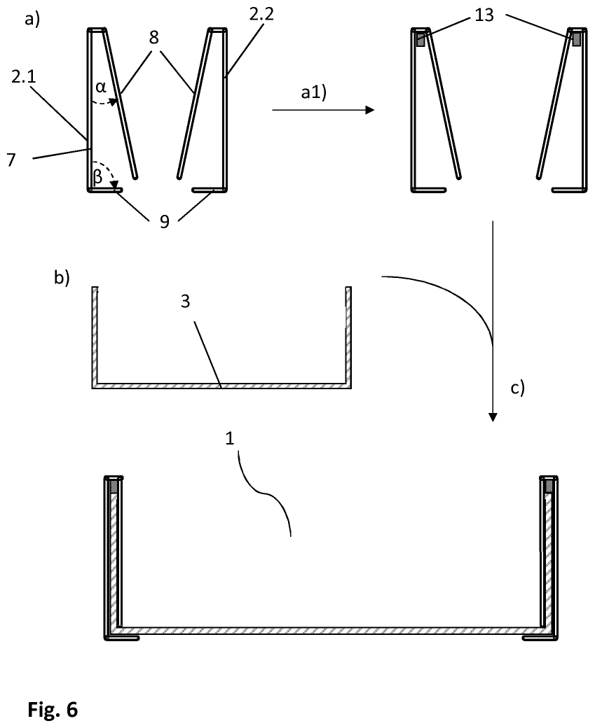

FIG. 5 a perspective side view of a bent spacer according to the invention,

FIG. 6 a schematic representation of a method according to the invention.

FIG. 1 depicts a cross-section through a spacer I according to the invention. The spacer extends in the longitudinal direction, represented here by the X axis. The spacer I has a U-shaped main body 1, which extends in the X direction. The main body 1 includes the first metallic side section 2.1 and the second metallic side section 2.2 arranged parallel thereto on the opposite side. The two metallic side sections 2.1 and 2.2 are connected by a U-shaped polymeric connecting piece 3. The U-shaped polymeric connecting piece extends in the transverse direction, represented here by the Y axis. The polymeric connecting piece 3 forms the lower limit of the main body 1 and delimits the intermediate space 11, which is situated between the first and the second metallic side sections and above the polymeric connecting piece.

The terms “below” and “above” refer to the Z axis. The Z axis is defined as the direction that is orthogonal to the longitudinal axis X and the transverse axis Y. “Above” refers to the region that faces in the direction of the inner interpane space and “below” refers to the region that faces in the direction of the outer interpane space.

The two metallic side sections have in each case a side wall 7 and a retaining arm 8, which, together, form an assembly groove 6. The assembly groove 6 of the first metallic side section 2.1 accommodates the first leg 3.1 of the U-shaped polymeric connecting piece 3, and the assembly groove 6 of the second metallic side section 2.2 accommodates the second leg 3.2 of the U-shaped polymeric connecting piece 3. The assembly groove 6 runs substantially parallel to the side wall 7. The assembly grooves 6 have profiling in the shape of longitudinal ribs that extend in the longitudinal direction (X). The longitudinal ribs are located both on the side wall 7 and on the retaining arm 8.

This profiling improves the fixing of the polymeric connecting piece in the assembly grooves. The first and second metallic side sections 2.1 and 2.2 are, for example, made of aluminum by extrusion and have a uniform wall thickness (thickness of side wall and retaining arm) of 0.8 mm.

The two metallic side sections 2.1 and 2.2 have in each case a fixing projection 9, implemented as an extension of the respective side wall 7. The fixing projection 9 of the second metallic side section 2.2 is bent around the corner region 12.2 of the U-shaped polymeric connecting piece 3 and fixes the polymeric connecting piece 3 in the assembly groove 6. The bent fixing projection 9 keeps the polymeric connecting piece 3 from slipping out downward and increases the stability of the spacer. The angle β (beta) between the fixing projection 9 of the second metallic side section 2.2 and the associated side wall 7 is approx. 90°. For purposes of illustration, the fixing projection 9 of the first metallic side section 2.1 is not yet folded in the drawing and encloses an angle β (beta) of approx. 180° with the associated side wall 7. A previously made indentation is visible at the transition between the side wall 7 and the fixing projection 9. Along this indentation, the fixing projection 9 can be bent in the direction of the dashed arrow during production of the spacer. In a finished spacer I according to the invention, both fixing projections are bent over and surround the corner regions 12.1 and 12.2 of the polymeric connecting piece. A fixing projection extends in the transverse direction all the way to the retaining arm 8 such that the polymeric connecting piece is clamped between the fixing projection 9 and the retaining arm. In the example, this corresponds to approx. f=2 mm. With a total width of the U-shaped main body of u=16 mm, a region of 16 mm−2×2 mm=12 mm remains free. Thus, no thermally conductive connection can be made through the two fixing projections 9.

The polymeric connecting piece 3 has, for example, a total thickness of 0.3 mm and is made of polyethylene terephthalate (PET). This provides good stability for the spacer and, at the same time, thermal conductivity is low thanks to the low material thickness. A moisture-proof barrier 4 is arranged over the entire polymeric connecting piece 3 on the side facing the intermediate space 11 of the spacer. The moisture-proof barrier 4 is protected against mechanical stresses by the arrangement in the intermediate space 11. The moisture-proof barrier 4 prevents penetration of moisture into the inner interpane space. Together with metallic side sections 2.1 and 2.2, complete sealing against moisture from the outer interpane space is thus formed. Even moisture that is possibly bound in the material of the polymeric connecting piece 3 cannot make its way into the inner interpane space. This is a substantial advantage relative to conventional polymeric hollow profile spacers, which usually have a moisture-proof barrier on their outer side. The moisture stored in the polymeric hollow profile before assembly of the insulating glass unit must then be bound by the desiccant, which already reduces the capacity of the desiccant starting at the time of installation.

In the example, the moisture-proof barrier 4 is a metal-containing barrier film. The barrier film comprises two aluminum layers with a thickness of 20 nm each and two PET layers each 12 μm thick. The polymeric layers and the metallic layers are arranged alternatingly. Such a film excellently seals the spacer against the penetration of moisture. An adhesion-promoter layer 15 in the form of a 10-nm-thick coating made of aluminum and aluminum oxide is applied on the side of the polymeric connecting piece facing the outer interpane space. This adhesion-promoter layer 15 improves the adhesion to the secondary sealant 25 in the finished insulating glass unit.

A sealing means in the form of a butyl cord 13 is provided in the assembly groove 6 of the two metallic side sections 2.1 and 2.2. The butyl seals the connection between the polymeric connecting piece 3 and the metallic side sections 2.1 and 2.2 and thus improves the leak tightness of the spacer. In the example, the spacer has a height of h=6.5 mm and the assembly groove is m=3 mm high. This corresponds to a share of 46% of the height of the spacer or of the height of the side wall. Thus, compared to an assembly groove 6 that extends over the entire height of the side wall, material is saved and stable fixing of the polymeric connecting piece is nevertheless achieved.

A desiccant in the form of an extruded desiccant body 10 is arranged in the intermediate space 11 of the spacer. The desiccant body is made of a silicone binder with an integrated molecular sieve. The desiccant body is in the form of a strip that is attached to the second metallic side section 2.2 via an adhesive 14. In the transverse direction, the desiccant body 10 does not extend over the entire width u of the spacer. This prevents heat transfer through the desiccant body from the first pane to the second pane in the finished insulating glass unit.

A cover film 5 that extends from the first metallic side section 2.1 to the second metallic side section 2.2 is attached on the upper side of the U-shaped main body. The cover film 5 thus closes off intermediate space 11 and the desiccant 10 contained therein is concealed. The cover film is permeable to water vapor and, in the example, is a 0.1 mm, thin, expandable, and flexible polypropylene film. The cover film is glued to the metallic side sections 2.1 and 2.2 and is arranged such that it engages around the metallic side sections in the upper region. Thus, it is additionally clamped between the pane and the spacer in the finished insulating glazing.

FIG. 2 depicts a cross-section of the edge region of an insulating glass unit II according to the invention with the spacer I depicted in FIG. 1. The first pane 21 is connected via a primary sealant 24 to the side wall 7 of the first metallic side section 2.1, and the second pane 22 is mounted via the primary sealant 24 on the side wall 7 of the second metallic side section 2.2. The primary sealant 24 is a cross-linking polyisobutylene. The inner interpane space 26 is situated between the first pane 21 and the second pane 22 and is delimited by the cover film 5 of the spacer I according to the invention. The intermediate space 11 is connected to the inner interpane space 26 via the water-vapor permeable cover film 5 such that the desiccant 10 absorbs the humidity from the inner interpane space 26. The first pane 21 and the second pane 22 protrude beyond the side walls 7 of the spacer I such that an outer interpane space 27 is created, which is situated between the first pane 21 and the second pane 22 and is essentially delimited by the polymeric connecting piece 3 of the spacer. The edge of the first pane 21 and the edge of the second pane 22 are arranged at the same height. The outer interpane space 25 is only partially filled with a secondary sealant 25. A central region 28 of the polymeric connecting piece 3 is free of secondary sealant 25. The secondary sealant is arranged only in the outer regions that are adjacent the first pane 21 and the second pane 22. Thus, no continuous thermally conductive connection between the panes 21 and 22 is established by the secondary sealant. The central region that remains free is made of 0.3-mm-thick PET, which is insensitive to external influences and mechanical stresses. Consequently, this embodiment is very stable despite non-continuously applied secondary sealant. The secondary sealant 25 is, for example, a silicone. Silicones absorb the forces acting on the edge seal particularly well and thus contribute to high stability of the insulating glass unit II. The first pane 21 and the second pane 22 are made of soda lime glass with a thickness of 3 mm.

FIG. 3 depicts a cross-section through an edge region of an insulating glass unit II according to the invention with a spacer I according to the invention with a receiving profile 30. The spacer I is essentially produced in the same way as that depicted in FIG. 1. The additional receiving profile 30 has a receiving groove 35 that accommodates the middle pane 23. The middle pane 23 divides the inner interpane space 26 into two inner interpane spaces. The receiving groove 35 contains an insert 36 made of a butyl, which stabilizes the middle pane 23 in the receiving groove and prevents rattling of the pane 23 in the receiving groove. The insert 36 is implemented such that the two inner interpane spaces are connected to one another such that a gas exchange can occur therebetween. This is achieved by interruptions in the insert, i.e., there are multiple sections without insert in the longitudinal direction. A gas exchange between the two inner interpane spaces is advantageous since in the event of large temperature differences between the two interpane spaces, the mechanical loads on the edge seal can thus be reduced. Like the metallic side sections 2.1 and 2.2, the receiving profile 35 is made of aluminum by extrusion. The receiving profile 35 has a first inner assembly groove 31 and a second inner assembly groove 32. The polymeric connecting piece is divided into a first polymeric connecting piece 33 and a second polymeric connecting piece 34. The first polymeric connecting piece is located in the assembly groove 6 of the first metallic side section 2.1 and the first inner assembly groove 31 and is fixed by the first inner fixing projection 41. The second polymeric connecting piece 34 is arranged in the assembly groove 6 of the second metallic side section 2.2 and the second inner assembly groove 32 and is fixed there by the second inner fixing projection 42. The receiving profile 35 additionally has two support projections 43 and 44, serving in each case for the attachment of a cover film. The first cover film 37 is glued onto the first support protrusion 43 and is arranged such that it protrudes into the receiving groove 36. As a result, a particularly stable attachment is achieved. The attachment of the first cover film 37 is also done by gluing to the first metallic side section 2.1. The second cover film 38 is attached analogously to the first cover film 37 on the second support protrusion 44 and the second metallic side section 2.2. The receiving profile 35 divides the intermediate space into a first intermediate space 39 and a second intermediate space 40. In the example, a desiccant body, which is in each case attached to the receiving profile, is arranged in each intermediate space. By means of the arrangement of desiccant in both intermediate spaces 39 and 40, the absorption capacity for moisture from the inner intermediate spaces is maximized. An embodiment with desiccant in only one intermediate space is also possible since a gas exchange between the two intermediate spaces is possible. The secondary sealant 25 is arranged in the outer interpane space such that two middle regions remain free. The edge regions, where the outer panes adjoin the spacer, are provided with the secondary sealant, which is important for the stability of the edge seal. A secondary sealant 25 is also arranged in the region of the receiving profile 35, which improves the sealing in this region and is additionally responsible for improving the stability of the edge seal.

FIG. 4 depicts a spacer I according to the invention with an incision 45. In the region of the incision 45, the spacer I can be bent over such that a corner of a spacer frame is created there, as is depicted in FIG. 5. The incision 45 has a V-shaped cross-section and extends in the transverse direction (Y direction) of the spacer. In other words, the spacer is cut over its entire width. The open side of the V is at the upper side (Z direction) of the spacer and the point of the V is exactly above the base of the polymeric connecting piece 3. In the example, the two sides of the V 46 and 47 enclose an angle of approx. 90° such that after the bending of the spacer at the incision point, a spacer frame with a right-angled corner is obtained, as depicted in FIG. 5. The fixing projections 9 of the first and second metallic side sections are not cut; and, thus, after bending, they have an additional stabilizing effect on the spacer frame.

FIG. 6 depicts a possible embodiment of a method for producing a spacer. In the first step, the first metallic side section 2.1 and the second metallic side section 2.2 are provided by roll forming. For this, a 0.1-mm-thick galvanized steel sheet is bent such that the fixing projection 9 is already bent and encloses an angle β (beta) of 90° with the side wall 7. The retaining arm 8 encloses an angle α (alpha) of approx. 10° to 20° with the side wall 7, i.e., the position of the assembly groove 6 is already predetermined. The angle α (alpha) can also be selected larger or smaller, as needed depending on the subsequent process steps. The assembly groove 6 extends along the entire side wall 7. The shape is particularly easy to produce by roll forming, since there is only one kink at the transition between the retaining arm and the side wall, in contrast to the example depicted in FIG. 1, in which the assembly groove extends along only one part of the side wall. In addition, the stability of the spacer is increased by the large assembly groove, which is particularly advantageous in the case of the thin steel sheet.

The opening between the retaining arm 8 and the fixing projection 9 is large enough that the polymeric connecting piece 3 can be inserted there in step c). In the following step a1), a butyl cord 13 is placed in the assembly groove 6 at the point where the side wall 7 of a metallic side section adjoins the retaining arm 8. In step b), the polymeric connecting piece 3 is provided. This is a 0.3-mm-thick PET piece with a moisture-proof barrier coating 4 on the side facing the intermediate space in the installed position in the form of a 200-nm-thick aluminum layer. On the side of the PET piece facing away from the intermediate space in the installed position, a 30-nm-thick silicon dioxide layer is arranged as an adhesion promoter 15. After heating, the PET piece is bent at the kinks into a U-shape. In step c), this PET piece is inserted through the openings between the retaining arm 8 and the fixing projection 9 into the two metallic side sections 2.1 and 2.2. The two retaining arms 8 are then pressed in the direction of the side walls 7 of the side sections 2.1 and 2.2 such that the U-shaped polymeric connecting piece 3 is fixed in the assembly grooves 6. Thus, manufacture of the U-shaped polymeric main body 1 is finished. In additional steps, desiccant can be introduced into the intermediate space and, following that, the cover film can be applied.

### LIST OF REFERENCE CHARACTERS

I spacer
II insulating glass unit, insulating glazing
1 U-shaped main body
2.1 first metallic side section
2.2 second metallic side section
3 polymeric connecting piece
3.1, 3.2 legs of the polymeric connecting piece
4 moisture-proof barrier coating/barrier film
5 cover film
6 assembly groove
7 side wall
8 retaining arm
9 fixing projection
10 desiccant
11 intermediate space
12.1, 12.2 corner regions of the U-shaped connecting piece
13 sealing means
14 adhesive
15 adhesion-promoter layer
21 first pane
22 second pane
23 middle pane
24 primary sealant
25 secondary sealant
26 inner interpane space
27 outer interpane space
28 central region on the outer side of the polymeric connecting piece
30 receiving profile
31 first inner assembly groove
32 second inner assembly groove
33 first polymeric connecting piece
34 second polymeric connecting piece
35 receiving groove
36 insert
37 first cover film
38 second cover film
39 first intermediate space
40 second intermediate space
41 first inner fixing projection
42 second inner fixing projection
43 first support protrusion
44 second support protrusion
45 V-shaped incision
46 first side of the V
47 second side of the V
u width of the U-shaped main body; width of the spacer
f length of the fixing projection
h height of the spacer
m height of the assembly groove

1. A spacer for insulating glass units, comprising:
a U-shaped main body extending in a longitudinal direction including a first metallic side section, a second metallic side section arranged parallel thereto, a polymeric connecting piece extending in a transverse direction, which connects the first and second metallic side sections and forms a lower limit of the main body, and an intermediate space arranged above the polymeric connecting piece between the first and second metallic side sections, wherein
the first and second metallic side sections each include at least one side wall for connecting to a glass pane and a retaining arm, which protrudes into the intermediate space, and the retaining arm forms an assembly groove with the side wall, which groove runs substantially parallel to the side wall,
the polymeric connecting piece is U-shaped and includes two legs that are inserted into the assembly grooves of the first and second metallic side sections.

2. The spacer according to claim 1, wherein the first and second metallic side sections each have case a fixing projection, which surrounds a corner region of the U-shaped polymeric connecting piece and whereby the polymeric connecting piece is fixed in the assembly groove.

3. The spacer according to claim 1, wherein the polymeric connecting piece includes at least one moisture-proof barrier.

4. The spacer according to claim 1, wherein an adhesion-promoter layer is arranged on the side of the polymeric connecting piece facing away from the intermediate space.

5. The spacer according to claim 1, wherein a sealing means is provided in the assembly groove.

6. The spacer according to claim 1, wherein the first and second metallic side sections are produced by roll forming or by extrusion.

7. The spacer according to claim 1, wherein a cover film extends in the transverse direction between the first metallic side section and the second metallic side section and thus closes the intermediate space.

8. The spacer according to claim 1, wherein in the intermediate space, a desiccant is arranged.

9. The spacer according to claim 1, comprising a receiving profile for an additional pane, wherein the receiving profile is arranged between the first metallic side section and the second metallic side section and wherein the receiving profile includes a receiving groove or the additional pane, which groove extends in the longitudinal direction.

10. The spacer according to claim 9, wherein the receiving profile is implemented as a metallic receiving profile.

11. The spacer according to claim 9, wherein
the polymeric connecting piece is divided by the receiving profile into a first U-shaped polymeric connecting piece and a second U-shaped polymeric connecting piece,
the receiving profile has a first inner assembly groove and a second inner assembly groove, and
one leg of the first U-shaped polymeric connecting piece is received in the first inner assembly groove, and one leg of the second polymeric connecting piece is received in the second inner assembly groove.

12. A method for producing a spacer according to claim 1 comprising:
a) extruding or roll forming the first metallic side section and the second metallic side section,
b) providing the U-shaped polymeric connecting piece,
c) inserting and fastening the U-shaped polymeric connecting piece in the assembly grooves of the two metallic side sections.

13. An insulating glass unit, comprising a first pane, a second pane, a spacer according to claim 1 arranged circumferentially between the first pane and the second pane, wherein
the first pane is attached to the side wall of the first metallic side section via a primary sealant,
the second pane is attached to the side wall of the second metallic side section via a primary sealant,
the spacer separates an inner interpane space from an outer interpane space, and
a secondary sealant is arranged in the outer interpane space.

14. A method for producing an insulating glass unit according to claim 13, comprising
d) providing a spacer according to claim 1,
e) bending the spacer to form a spacer frame, which is closed at one point,
f) providing a first pane and a second pane,
g) fixing the spacer between the first pane and the second pane via a primary sealant,
h) pressing the pane assembly comprising the first and second panes and the spacer, and
i) at least partially filling the outer interpane space with a secondary sealant.

15. A method comprising utilizing the insulating glass unit according to claim 13 as a building interior glazing, a building exterior glazing, and/or a façade glazing.

16. The spacer according to claim 3, wherein the at least one moisture-proof barrier is in the form of a metal coating, a ceramic coating, a polymer film, or a multilayer film with polymeric and metallic layers or with polymeric and ceramic layers or with polymeric, metallic, and ceramic layers.

17. The spacer according to claim 4, wherein an adhesion-promoter layer is a metal-containing thin film or a ceramic thin film.

18. The spacer according to claim 5, wherein a sealing means is a butyl cord.

19. The spacer according to claim 7, wherein the cover film at least partially surrounds the first and second metallic side sections in the upper region.

20. The spacer according to claim 8, wherein the desiccant has a continuous desiccant body in the form of a strip or flexible tube.
